(19) United States
(12) Patent Application Publication
(10) Pub. No.: US 2024/0336747 A1
(43) Pub. Date: Oct. 10, 2024

(54) METAL-GLYCEROL DECORATED ANTIMICROBIAL POLYMER COMPOSITE

(71) Applicant: SABIC Global Technologies B.V., Bergen op Zoom (NL)

(72) Inventors: Tayirjan Taylor Isimjan, Bengaluru (IN); Maher N. Aloufi, Bengaluru (IN); David West, Bengaluru (IN); Toseef Ahmed, Bengaluru (IN)

(21) Appl. No.: 18/690,069

(22) PCT Filed: Apr. 24, 2023
(86) PCT No.: PCT/EP2023/060595

§ 371 Date: Mar. 7, 2024

(30) Foreign Application Priority Data
May 2, 2022 (EP) 22171197.1

(51) Int. Cl. C08J 3/20; A01N 25/10; A01N 59/16; C08K 3/28

(52) U.S. Cl. CPC C08J 3/203; A01N 25/10; A01N 59/16; C08K 3/28; C08J 2323/06; C08K 2201/013

(57) ABSTRACT

Disclosed is a method of preparing a polymer composite component, wherein the method comprises uniformly dispersing glycerol and metal ions on a polymer powder to create a polymer composite powder, extruding the polymer composite powder at a temperature of at least 80° C., thereby converting a portion of the metal ions to metal atoms, and then forming the component from the extruded polymer composite. The component can be a thin film, to be applies to surfaces to increase antimicrobial properties.

### CROSS REFERENCE TO RELATED APPLICATIONS

This application is a National Stage Application under 35 U.S.C. § 371 and claims the benefit of International Application No. PCT/EP2023/060595, filed Apr. 24, 2023, which claims priority to EP 22171197.1, filed May 2, 2022, the contents of both of which are incorporated herein in their respective entirety.

### TECHNICAL FIELD

The present disclosure is directed to the field of anti-microbial polymer composite components and methods of making them.

### BACKGROUND

Microbial infections pose significant global health challenges. Moreover, the continuous variations arising from genetic mutations are slowing down the process of developing effective vaccines by prolonging the time required for clinical trials. Therefore, it is essential to develop an in-vitro approach to stopping viruses before they infect the human body. Surface-modified polymer composites containing active components are a safe and universal method for deactivating various microbial agents in vitro, regardless of genetic mutations. Silver (Ag), along with two other transition metals copper (Cu) and Zinc (Zn), have been studied extensively as antimicrobial additives over the years due to the fact that their metallic particles and corresponding ions can strongly bind to the proteins and genomes of microbial agents. Silver nanoparticles have also proven to be active against several types of viruses including HIV, hepatitis B, herpes simplex, respiratory syncytial, and monkey pox. In addition, glycerol and its derivatives, which follow a different mechanism, are widely used as safe and natural antimicrobials, accepted by the U.S. Food and Drug Administration (FDA). By combining the metal ions with glycerol, enhanced antimicrobial activity is achieved.

It is also known that Ag metal is better as an anti-microbial than Ag ions. But adding pure silver to a polymer composite and having it in high concentration on the surface of a component is a challenge. In prior art applications, most of the metals are embedded inside the polymer component, thus resulting in less active metal sites being exposed to the surface. Therefore, what is needed is an improved Ag-based scalable antibacterial polymer composite with a relatively high concentration of silver at the surface (i.e., the surface is “decorated” with silver), made using a chemical linker-free, simple, and cost-effective method.

### BRIEF SUMMARY

Our approach consists of first impregnating the surface of a polymer powder with metal ions dissolved in a solvent having a blend of ethanol, acetonitrile and glycerol and then drying it, thus creating a polymer composite powder. We then pass the polymer composite powder through an extruder at an elevated temperature, causing the metal ions to reduce to metal during the extrusion. A finished product is then formed or shaped into a desired component, such as a thin film.

Such an approach utilizes the unique synergy between metal particles and glycerol to produce highly efficient antimicrobial resins. By combining the metal ions with glycerol, we anticipate an enhanced antimicrobial activity since glycerol reduces the metal ions at high temperatures (>80° C.) to form small metal particles across the surface of the extruded powders, which can further increase antimicrobial activity, while the glycerol itself acts as an antimicrobial additive when blended with the polymer composite powders. The unique combination of a solvent having a blend of ethanol/acetonitrile/glycerol dissolves the metal salt and create a uniform dispersion on the polymer powders. Further, the ethanol wets the polymer surface due to the lowering of surface energy, thereby creating a uniform dispersion of the metals on the polymer surface. The glycerol further prevents the aggregation of the metal particles due to its high viscosity. This methods maximizes the number of metal active sites exposed on the surface thereof reducing the required metal loading. And, the preparation process is simple and scalable.

In one embodiment, the antimicrobial effect of metal-based polymer composites has been enhanced using a non-conventional processing method to produce homogeneous materials, wherein the metal ions, including, e.g., Ag⁺, Cu²⁺ and Zn²⁺, are uniformly dispersed on the surface of polymer powders using a dry impregnation approach with a solvent having acetonitrile/glycerol/ethanol. The low surface tension of ethanol along with the viscous glycerol not only promotes dispersion of the metal ions but also prevents aggregation during a subsequent solvent evaporation process. Most importantly, the glycerol acts as the reducing agent to convert the metal ions into metal particles during the elevated-temperature extrusion, the metal particles showing higher antimicrobial activities compared to metal ions alone. The metal/glycerol-based polymer composite components were prepared in three steps as follows. First, the metal-based metal-organic solutions are prepared at a certain concentration and used to impregnate the surface of polymer powders, with the powders subsequently dries at 80° C. for 2 hours. The resulting partially metal-decorated polymer composite powder is then mixed using an extruder at an elevated temperature. Finally, polymer composite components, such as thin films, can be cast by compression molding the output from the extruder. More than one metal may be used, e.g., silver can be combined with copper or zinc.

Such a process can create a product that at 100 ppm of metal is comparable to previous blends that took 500 ppm of metal to achieve similar results. The metal nanoparticles tend to be uniformly dispersed and less than 1 μm in size.

The disclosure comprises a method of preparing a polymer composite component, wherein the method comprises first uniformly dispersing a reducing agent and metal ions on the surface of a polymer powder to create a polymer composite powder, melting and extruding the polymer composite powder at a temperature of at least 80° C., wherein a portion of the metal ions are converted to metal atoms, and then finally forming the component from the extruded polymer composite. The metal atoms include silver, copper or zinc, or combinations thereof. The forming step can be into a thin film or pellets. The step of uniformly dispersing the metal ions on the surface of the polymer powder is accomplished using a dry impregnation approach with a solvent having a blend of acetonitrile, glycerol and ethanol. The polymer can include polyethylene, polypropylene, polycarbonate, polyvinyl chloride, polyethylene terephthalate, nylon, acrylonitrile butadiene styrene, poly(methyl methacrylate), polystyrene or polyvinyl acetate, combinations of any of these. The metal ions can include water- or organic-soluble salts, said salts comprising nitrites, chlorites, acetates, ammonium nitrites, ammonium chlorites, ammonium acetates or blends thereof. The metal ions are reduced to metal atoms using a reducing agent, the agent comprising alcohols and their derivatives, said alcohols and derivatives comprising adonitol, arabinose, cellobiose, dulcitol, galactose, glycerol, glucose, inositol, lactose, maltose, mannitol, mannose, mellibiose, raffinose, salicin, sorbitol, sucrose, trehalose, xylose, or combinations thereof. The metal/metal ratio in a bi-metallic or tri-metallic systems can be from 100:1 to 1:100. The pore volume of the polymer powders can be between 0.1 to 3.0 ml/g. The percentage of metal in the polymer composite component can be from 10 ppm up to 20,000 ppm. After the polymer composite powder is prepare, it can then be dried at 80° C. for 2 hours. The polymer powder is preferably polyethylene. The polymer composite component can be a thin film that is cast by compression molding from the uniformly blended polymer composite powder and primary polymer. The polymer composite component is used to kill bacteria, fungi, algae, protozoa, and viruses. And, a portion of the metal ends up on or very close to the surface of the component.

The polymer composite component of the present disclosure can be used in range of articles and applications where there is a likelihood of transmission of microbes from one person to person. The use of polymer composite component in such articles and applications shall provide antimicrobial property, thereby reducing the transmission of microbes. The polymer composite component is part of a greater article of manufacture. Alternatively, the polymer composite component forms at least part of the surface of the greater article of manufacture. The articles where the polymer composite component can be used include, but not limited to, door handles, hand grab in vehicles such as train and bus, surfaces of touch panels such as bank ATM, flexible and rigid packaging articles, and so forth.

The terms “wt. %”, “vol. %” or “mol. %” refers to a weight, volume, or molar percentage of a component, respectively, based on the total weight, the total volume, or the total moles of the material that includes the component. In a non-limiting example, 10 moles of a component in 100 moles of the material means 10 mol. % of the component. The term “M” refers to a molar concentration of a component, based on the moles per 1 L volume. The term “mM” means one thousandth of an “M.” Any numerical range used through this disclosure shall include all values and ranges there between unless specified otherwise. For example, a boiling point range of 50° C. to 100° C. includes all temperatures and ranges between 50° C. and 100° C. including the temperature of 50° C. and 100° C.

The use of the words “a” or “an” when used in conjunction with the term “comprising,” “including,” “containing,” or “having” in the claims or the specification may mean “one,” but it is also consistent with the meaning of “one or more,” “at least one,” and “one or more than one.” The words “comprising” (and any form of comprising, such as “comprise” and “comprises”), “having” (and any form of having, such as “have” and “has”), “including” (and any form of including, such as “includes” and “include”) or “containing” (and any form of containing, such as “contains” and “contain”) are inclusive or open-ended and do not exclude additional, unrecited elements or method steps. The process of the present disclosure can “comprise”, “consist essentially of,” or “consist of” particular ingredients, components, compositions, etc., disclosed throughout the disclosure.

Other objects, features and advantages of the present disclosure will become apparent from the following figures, detailed description, and examples. It should be understood, however, that the figures, detailed description, and examples, while indicating specific embodiments of the disclosure, are given by way of illustration only and are not meant to be limiting. Additionally, it is contemplated that changes and modifications within the spirit and scope of the disclosure will become apparent to those skilled in the art from this detailed description. In further embodiments, features from specific embodiments may be combined with features from other embodiments. For example, features from one embodiment may be combined with features from any of the other embodiments. In further embodiments, additional features may be added to the specific embodiments described herein.

### BRIEF DESCRIPTION OF THE DRAWINGS

For a more complete understanding, reference is now made to the following descriptions taken in conjunction with the accompanying drawings, in which:

FIG. 1 is a representation of the process to prepare polymer composite according to embodiments of the disclosure.

FIG. 2 is a SEM/EDX and XPS analysis: (A) SEM image of film surface, particle compositions in the inset table (weight %) (B) EDX map of Ag, (C) EDX map of Cu, (D) Cu 2p3 XP spectrum and inset table showing the surface species observed by XPS analysis.

FIG. 3 shows the antiviral results of 100 ppm metal-glycerol decorated antimicrobial polymer composite component according to embodiments of the disclosure.

FIG. 4 shows a comparison of the anti-viral performance of a base polymer compared to a corresponding polymer composite component prepared as taught in this application.

FIG. 5 shows the results of antibacterial results of 500 ppm metal-glycerol decorated antimicrobial polymer composite component, with various ratios of silver to copper, according to embodiments of the disclosure.

FIG. 6 is a table showing the raw data related to FIG. 5, for antibacterial results of 500 ppm metal-glycerol decorated antimicrobial polymer composite component, with various ratios of silver to copper, according to embodiments of the disclosure.

FIG. 7 is a table showing the results of antibacterial testing using various amounts of metal and glycerol in a metal-glycerol decorated antimicrobial polymer composite component according to embodiments of the disclosure.

FIG. 8 shows SEM image and EDX maps of scaled-up film: (A) SEM image of film surface (B) EDX map of oxygen, (C) EDX map of Na, (D) EDX map of Cl, (E) EDX map of Ag, and (F) EDX map of Cu.

### DETAILED DESCRIPTION

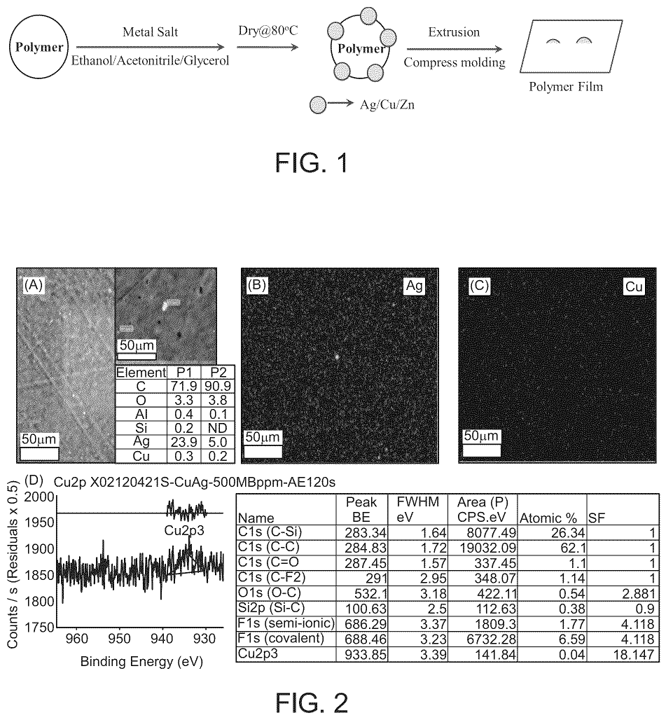

The process represented in FIG. 1 will now be described in more detail. The following is merely exemplary, and variations will still fall within the scope of this patent.

In one particular version, an ultra-low density polyethylene, such as SABIC's LLDPE-118, is used as the polymer powder. The polyethylene serves as a support upon which the metal ions will be deposited. Any number of other polymers may be used as a support.

We first prepare a solution of metal ions to impregnate the polymer powder. In one embodiment, AgNO₃ and Cu(NO₃)₂·3H₂O are dissolved in CH₃CN and diluted with ethanol to 10 ml to prepare a Ag/Cu (1:1, 50000 ppm) stock solution. This solution is then diluted with glycerol and ethanol. For instance, we can use 0.1 ml of the previously prepared solution, 0.5 ml of glycerol, and 10 ml of ethanol.

The metal ion solution was applied to the polymer powder using a dry impregnation or impregnation to incipient wetness method. The polymer powder is mixed with a solution of appropriate concentration, corresponding in quantity to, or slightly less than the total known pore volume. In this instance, we used 80%. The metal ion solution is mixed with the polymer powder using speed mixture until the material gelled. The now impregnated polymer composite powder was then dried in an oven at 80° C. for 2 hours.

The dried and impregnated polymer composite powder was then extruded. The extrusion process was carried out using a twin-screw compounder (a Xplore—MC15). Parameters used during the extrusion include:

Temperature: 180° C. under N2, 20 RPM feeding/exiting, 50 RPM extrusion for 8 min, 50 RPM extrusion for 8 min, 10 g of impregnated polymer powder, Purging with about 25 g raw LLDPE 118NG between runs, The Sheet/film casting was then accomplished using a HOT Platen Press (P 200 S Collin).

The extruded polymer composite material is then formed into a component using compression molding. The material can also be formed into finished component in any number of ways that are well known in the industry. In this particular embodiment the compression molding conditions was as following:

Sheet area=15×15 cm, Sheet thickness=2 mm, Temperature=190° C., Heating time=5 min, Cooling time=5 min, Pressure=80 bar.

The 100 ppm Ag/Cu/LLDPE formulation was scaled up to 10 kg scale using 1 wt % Ag/Cu MB, which was diluted two times and each time 10 wt % MB was used. Both MFI and density of the scaled up material was measured using standard test methods.

### Characterization

Penetration depth in X-ray photoelectron spectroscopy (XPS) refers to the distance that the X-rays can penetrate into the sample before being absorbed. It is determined by the energy and the intensity of the X-rays, as well as by the composition and the structure of the sample. The penetration depth for XPS is typically in the range of a few nanometers to several tens of nanometers, depending on the sample and the measurement conditions. In general, 10 nm depth is the reasonable estimate. This article provides a comprehensive overview of the principles of XPS and the factors that determine the penetration depth, including the instrumental parameters and the sample properties.

Ag/Cu (5 wt %)-LLDPE film samples were characterized using SEM-EDX (FEI Quanta 200 with EDAX Octane Elect EDX System) operated at the following settings: Acceleration Voltage: 20 KV, Working Distance: 10 mm, Spot Size: 4-5, Imaging Mode: BSE, Correction Routine: eZAF. The film samples were C evaporative coated for ˜1 sec. EDX analysis was performed in both area and spot modes and all contents were calculated in weight %. The samples of size 8 mm×8 mm were cut from the Ag/Cu-LLDPE film pieces and attached to 12.5 m SEM stubs using sticky carbon tabs. The film sample was handled with clean tweezers, and surfaces were not touched during sample preparation. 8 mm long film pieces were cross-sectioned using fresh stainless steel blades and attached to the same SEM stub. All samples showed fine C conducting coating cracks.

The XP spectra of Ag/Cu (5 wt %)-LLDPE film sample were collected by a Thermo Scientific Escalab 250 Xi having XP spectrometer with an Al Kα X-ray source. The X-ray spot size was 650×650 μm2. Charge compensation was carried out using a standard flood gun. Data was acquired using the settings given in Table 1. All peaks were corrected with respect to the binding energy of the adventitious C is peak at 284.8 eV.

TABLE 1
XPS Setting for Data Acquisition.

| | | Dwell | Step | Number of |
|---|---|---|---|---|
| Spectrum | PE(eV) | time (ms) | size (eV) | scans |
| Survey | 100 | 100 | 1 | 1 |
| High resolution | 30 | 200 | 0.1 | 10-30 |

All peaks were fitted using the SMART background option and peaks were modelled using Lorentzian/70% Gaussian mix.

The thermal degradation study was performed on scaled-up material using TGA (NETZSCH TG209F1 Iris instrument) in an inert environment (nitrogen gas) at 10° C./min heating rate in a temperature range of 25-600° C. The sample amount of ˜15 mg of was used for the TGA analysis. Antioxidant behavior of scaled-up material was assessed using oxidation induction time (OIT) test at temperatures of 200° C. and 210° C. using DSC. Both thermal stability and OIT tests were also performed on virgin base polymer.

Powder pore volume in dry impregnation refers to the total amount of empty space or voids within a powder material, such as a substrate or a filter. Dry impregnation involves the filling of these voids with a solid or a liquid material, typically a resin, in order to increase the mechanical strength and/or to provide other desired properties such as filtration, separation, or adsorption. The pore volume can be determined by various methods, including gas adsorption, mercury intrusion porosimetry, and helium pycnometry. It is expressed in units of volume per unit volume of the material, such as milliliters per gram or cubic centimeters per gram. The pore volume can play an important role in determining the suitability of a powder for a particular application and in optimizing the impregnation process. The simple way of measuring the powder pore volume (ml/g) in the lab is to measure minimum amounts of water used to just wet the 1 g of the powder. The pore volume of LLDPE-118 powder was measured to be around 1.0 ml/g.

### Antimicrobial Test

The antimicrobial test starts with a standardized test organism being inoculated onto the surface of the test material. The standard ISO 22196 test specifies an incubation period of 24 hours but other time periods can be accommodated. Surviving microorganisms are counted to evaluate the antimicrobial activity of the test material.

Counts are determined before and after incubation. Using a formula provided in the standard, the log of the difference between the 2 counts is determined to give a measurement of antimicrobial activity, as shown below:

$$R = log \frac{\# of bacteria untreated sample after 24 h ( B )}{\# of bacteria treated sample after 24 h ( C )} = log B - log C \qquad 25$$

$$R \text{:} antibacterial efficacy ( > 2 )$$

When tested as specified in JIS Z 2801, Sample 20201209-19 passes to show Anti-Microbial Activity where R is >2.0. The microbial agents used in this method are Staphylococcus aureus and Escherichia coli.

### Antiviral Test

The ISO21702 test method was used for the quantitative evaluation of virucidal activity on Ag/Cu-LLDPE film samples. The basis of the test method is the incubation of the viral inoculum in contact with the test sample for 6 hours without drying the inoculum. Then, the inoculated virus is recovered, and the concentration of the infective virus is determined. The antiviral performance is determined by comparing the recovered virus from the untreated and treated material after 6 hours. The samples are prepared according to the required dimension (5 cm×5 cm), and the samples should be flat and non-hydrophobic that allow laying the inoculum over the sample surface. Human coronavirus (Hcov-OC43) was used as the testing organism in the experiments.

### Results

SEM/EDX analysis show a high level of dispersions of Ag and Cu on the film surface. The Ag/Cu alloy particle size is between 1-5 μm (FIG. 2 A-C). The XPS shows Cu around 0.04 atom % on the surface after 2 min of etching with 500 eV Argon, indicating the nano-level dispersion of the Cu throughout the surface, something which is very difficult to detect by XPS using a sample prepared by prior art methods. However, XPS could not detect the Ag, which could be due to the lager particle size of Ag as compared to Cu (FIG. 2D).

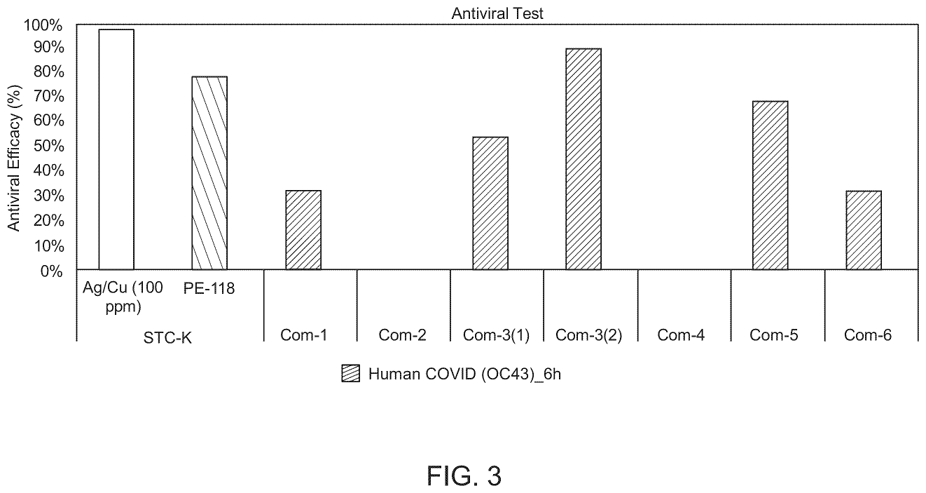

Yet, looking at the results in FIG. 3, the antiviral results on Human COVID (043) virus revealed that Ag/Cu on LLDPE showed 98% reduction in viruses after 6 hour, which is significantly better than most of the samples prepared using various commercial master batches, those various competitive samples designated as “Com-1 to Com-6”.

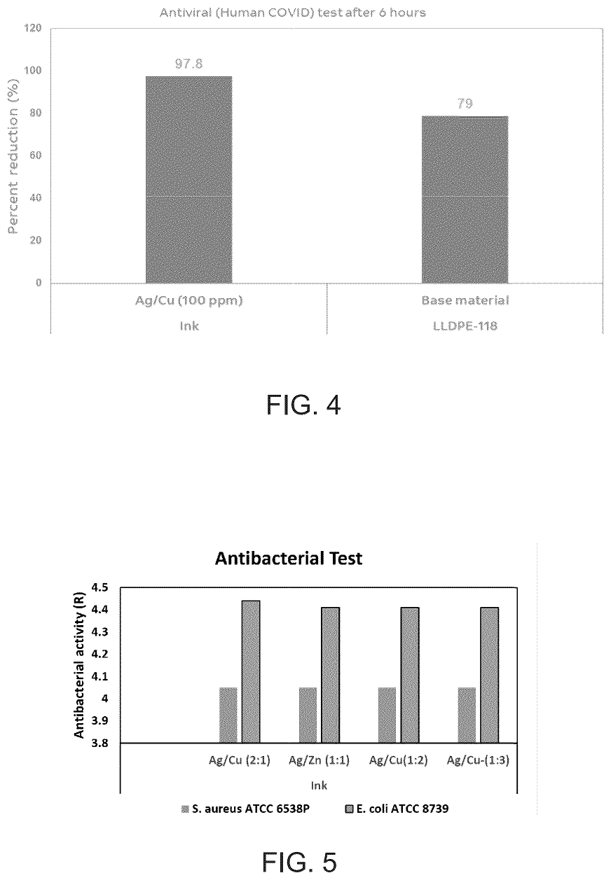

Referring now to FIG. 4, test results are shown comparing the base polymer with a corresponding polymer composite component, in which the base polymer is an ultra-low density polyethylene. The polymer composite component has added 100 ppm of a 50/50 mixture of silver and copper. As shown in FIG. 4. While the base polymer has a 79% reduction in COVID virus on its surface, the inventive component has a near 98% reduction.

Referring now to FIG. 5, test samples were prepared with various mixtures of metals, at various ratios. Specifically, Ag/Cu in a 2:1 ratio by weight, Ag/Zn in a 1:1 ratio, Ag/Cu in a 1:2 ratio, and Ag/Cu in a 1:3 ratio. The results indicate that the 500 ppm metal-loaded LLDPE showed very high antibacterial efficacies (R>4.0), regardless of the Ag/Cu and Ag/Zn ratio.

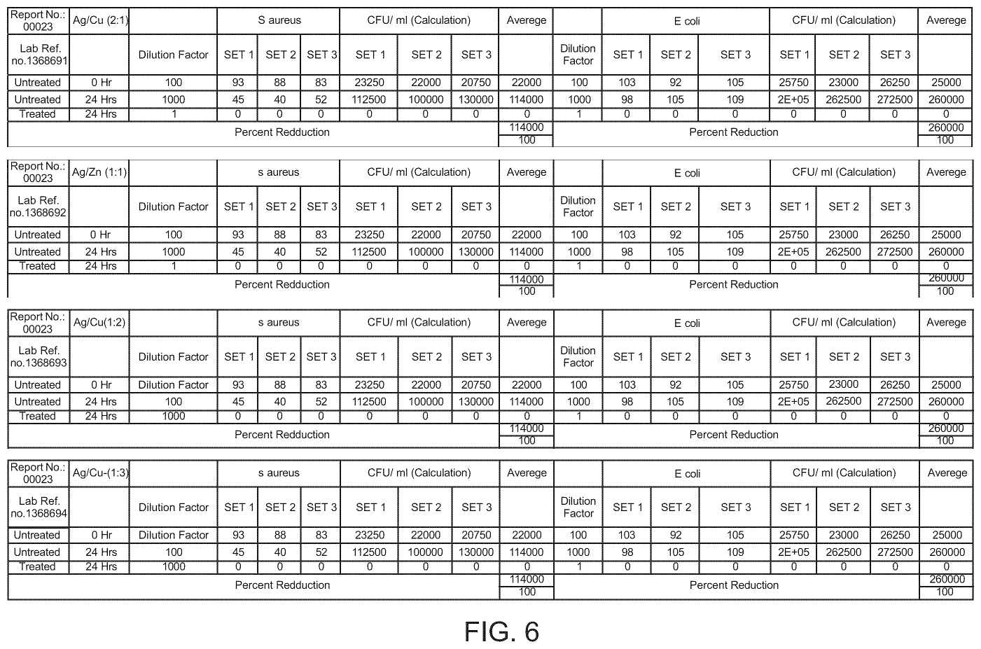

Further, the raw data, as shown in FIG. 6, indicates 100% killing efficiency towards both bacteria. So various metals or combination of metals may be utilized in the inventive concept and yield good results.

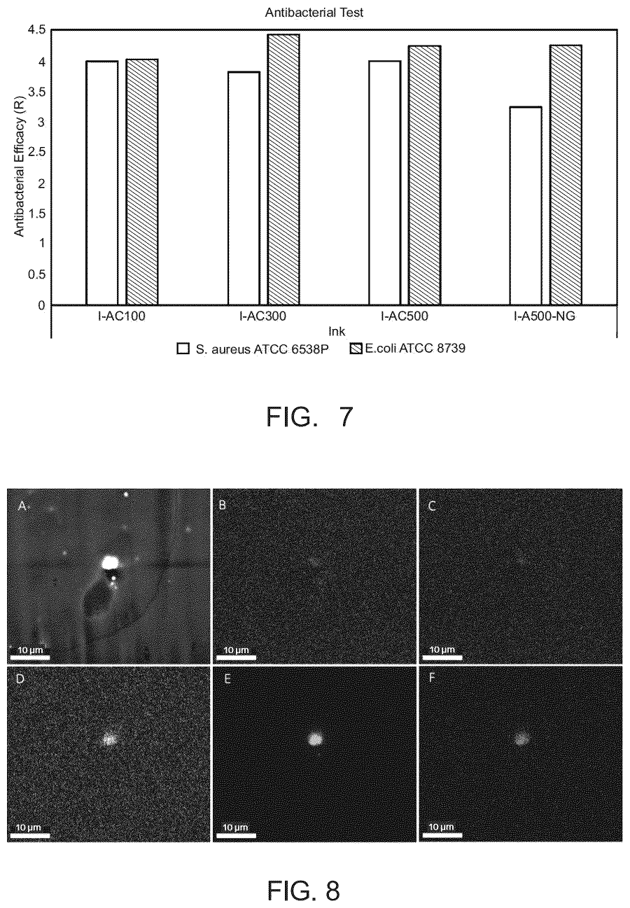

Looking now at FIG. 7, results are shown from antibacterial testing with S. aureus and E. coli, using various amounts of metal and glycerol. The first test, noted as 1-AC100, used a polymer with 100 ppm of metal. The next test, 1-AC300, used polymer with 300 ppm of metal. Test 1-AC500 used a polymer with 500 ppm of metal. And finally, test 1-AC500-NG, is also with a polymer with 500 ppm, but prepared without any glycerol.

This result shows that polymers with amounts of metal as low as 100 ppm are about as effective as those with 500 ppm. Further, the antibacterial activity declined when the glycerol was removed from the compounding process, indicating the important synergic affect between the metal and glycerol.

The results of scaled up material indicated that most of the physical properties are identical to the virgin polymer LLDPE-118 except the oxidation induction times which are much shorter for the composite than those of virgin LLDPE-118 indicating poor oxidation resistance of the former (Table 2). However, the scaled up samples showed outstanding antibacterial (FIG. 8) and anti-mold performances (Table 3).

TABLE 2

| | | | | | TGA | |
|---|---|---|---|---|---|---|
| | | | OIT | | (° C.) | |
| | MFI | Density | (min) | | | Degradation |
| Material | (190° C./21.6 g) | (g/cm³) | 200° C. | 210° C. | On set | Temperature |
| LLDPE + additives | 22.55 | 0.92 | 2.21 | 0.54 | 260 | 450.0 |
| LLDPE | 22.90 | 0.92 | 9.20 | 1.10 | 260 | 450.4 |

TABLE 3

| | Duration of the Test | | | |
|---|---|---|---|---|
| Sample | Week 1 | Week 2 | Week 3 | Week 4 |
| Ag-Cu (100 ppm) Ink/LLDPE-118 | 0 | 0 | 0 | 1 |
| Scale up | | | | |
| Control | 1 | 2 | 4 | 4 |

SEM images and elemental EDX maps of the scaled-up Ag/Cu(100 ppm)/LLDPE-118 show a uniform dispersion of the Cu and an apparent aggregation of Ag up to 3 μm in size. These results align with the XPS finding, which only detected Cu on the surface. Moreover, the evenly dispersed Na and Cl suggest NaCl contamination in the polymer (FIG. 8).

Thus, a superior method of creating a silver decorated polymer component is taught.

1. A method of preparing a polymer composite component, wherein the method comprises:
uniformly dispersing a reducing agent and metal ions on a polymer powder to create a polymer composite powder;
melting and extruding the polymer composite powder at a temperature of at least 80° C., wherein a portion of the metal ions are converted to metal atoms; and, forming the component from the extruded polymer composite,
wherein the metal atoms are silver, copper, zinc, or combinations thereof, and
further wherein the step of uniformly dispersing the metal ions on the surface of the polymer powder is accomplished using a dry impregnation approach with a solvent having a blend of acetonitrile, glycerol and ethanol.

2. The method of claim 1, wherein the step of forming comprises making a thin film or pellets.

3. The method of claim 1, wherein the primary polymer comprises polyethylene, polypropylene, polycarbonate, polyvinyl chloride, polyethylene terephthalate, nylon, acrylonitrile butadiene styrene, poly(methyl methacrylate), polystyrene or polyvinyl acetate, or combinations thereof.

4. The method of claim 1, wherein the metal ions comprise water- or organic-soluble salts, said salts comprising nitrites, chlorites, acetates, ammonium nitrites, ammonium chlorites, ammonium acetates or blends thereof.

5. The method of claim 1, wherein the reducing agent comprises alcohols and their derivatives, said alcohols and derivatives comprising adonitol, arabinose, cellobiose, dulcitol, galactose, glycerol, glucose, inositol, lactose, maltose, mannitol, mannose, mellibiose, raffinose, salicin, sorbitol, sucrose, trehalose, or xylose or combinations thereof.

6. The method of claim 1, wherein a metal/metal ratio in a bi-metallic or tri-metallic system is from 100:1 to 1:100.

7. The method of claim 1, wherein the pore volume of the polymer powders are between 0.1 to 3 ml/g.

8. The method of claim 1, wherein the percentage of metal in the component is from 10 ppm up to 20000 ppm.

9. The method of claim 1, wherein a silver-based metal-organic solution is prepared and used to impregnate plastic powders, wherein the plastic powders are then dried at 80° C. for 2 hours.

10. The method of claim 1, wherein the polymer powder is polyethylene.

11. The method of claim 10, wherein the polymer composite component is a thin film that is cast by compression molding from the uniformly blended plastic powder.

12. The method of claim 1, wherein the polymer composite component is used to kill bacteria, fungi, algae, protozoa, and viruses.

13. The method of claim 1, wherein a portion of the metal ended up on very close to the surface of the component.

14. The method of claim 1, wherein the polymer composite component is part of a greater article of manufacture.

15. The method of claim 14, wherein the polymer composite component forms at least part of the surface of the greater article of manufacture.
